(19) United States
(12) Patent Application Publication
(10) Pub. No.: US 2019/0047039 A1
(43) Pub. Date: Feb. 14, 2019

(54) MACHINING SYSTEM FOR MACHINING ROUND MATERIAL, COMPRISING A FEEDER ASSEMBLY HAVING PERMANENT MAGNETS

(71) Applicant: Hubert RAPPERSTORFER, Steinerkirchen (AT)

(72) Inventor: Hubert RAPPERSTORFER, Steinerkirchen (AT)

(21) Appl. No.: 16/078,322

(22) PCT Filed: Feb. 22, 2017
(86) PCT No.: PCT/AT2017/060038

§ 371 Date: Aug. 21, 2018

(30) Foreign Application Priority Data
Feb. 22, 2016 (AT) A50118/2016

(51) Int. Cl. B21F 23/00; B21D 43/00; B21D 43/12; B21D 43/28; B21F 11/00; B65G 15/58

(52) U.S. Cl. CPC B21F 23/00; B21D 43/006; B65G 15/58; B21D 43/28; B21F 11/00; B21D 43/12

(57) ABSTRACT

A machining system for cutting round material to length, in particular concrete steel. The machining system has a feeder assembly for feeding and positioning the round material, and a cutting device for cutting the round material to length. The feeder assembly is designed as a belt conveyor, wherein in a conveyor permanent magnets are arranged, which are positioned below a receiving surface for receiving round material, wherein the round material can be fixed to the receiving surface of the conveyor means by the permanent magnets.

The invention relates to a machining system for machining round material, in particular concrete-reinforcing steel.

Concrete-reinforcing steel and its shaping are known from EP 1 231 331 A2. It is difficult to cut such concrete-reinforcing steel to a precise length, since it is difficult to determine the advancing length of a rod material being fed to a cut-to-length apparatus, due to the ribbed surface of the concrete-reinforcing steel. Cutting systems for cutting concrete-reinforcing steel to length, which are known from the state of the art, have only a low accuracy.

A machine for production of reinforcement steel mesh is known from EP 0 862 958 B1, for example, which machine comprises two rollers, between which a reinforcement rod is accommodated and which are driven when a movement of the reinforcement rod occurs. As a result, the length or an advance of the reinforcement rod can be detected.

The measuring apparatus known from EP 0 862 958 B1 has the disadvantage that the result of the measurement by means of the friction rollers is only very imprecise, particularly in the case of reinforcement steel having a rough surface.

It was the task of the present invention to overcome the disadvantages of the state of the art and to make available a machining system by means of which round material, in particular concrete-reinforcing steel, in the form of rod material or wound up on reels, can be machined precisely.

This task is accomplished by means of an apparatus according to claim 1.

According to the invention, a machining system for machining round material, in particular concrete-reinforcing steel, is provided. The machining system comprises a feeder apparatus for feeding and positioning the round material, and a machining apparatus for machining the round material. The feeder apparatus is configured as a belt conveyor, wherein permanent magnets are disposed on a conveying means, which magnets are positioned below an accommodation surface for accommodating round material, wherein the round material can be fixed in place on the accommodation surface of the conveying means by means of the permanent magnets. In particular, it can be provided that the machining system is configured as a cutting system for cutting round material to length. Furthermore, it can be provided that multiple accommodations for accommodating multiple round materials next to one another are provided on the conveying means.

An advantage of the configuration of the machining system according to the invention is that the round material can be fixed in place on the conveying means by means of the permanent magnets disposed in the conveying means. Fixing in place is understood to mean that the round material is pressed against the conveying means by means of the magnetic force of the permanent magnets, and thereby the friction force between round material and conveying means is increased. As a result, it can be achieved that during the advancing movement, the round material is not displaced relative to the accommodation surface of the conveying means, and thereby the advancing movement of the round material can be precisely controlled by way of the advancing movement of the conveying means. In this regard, the round material can also have a ribbed surface, as is the case for concrete-reinforcing steel, for example.

In a further embodiment variant, it is also conceivable that the machining apparatus of the machining system comprises a bending head or also multiple bending heads, by means of which the round material can be bent. In addition, a cutting system and a bending head can be combined in the machining system.

Furthermore, it can be practical that the conveying means is configured in such a manner that the round material can be centered on the conveying means at a predetermined position, with reference to the width of the conveying means, by means of a centering element. It is advantageous, in this regard, that the round material cannot roll away to the side on the conveying means, and thereby it is guaranteed that the round material is always introduced into the cut-to-length apparatus in a specific position. This increases the precision of the machining system.

Furthermore, it can be provided that the centering element is configured in the form of a groove-shaped depression, which is disposed on the accommodation surface of the conveyor belt, wherein the groove-shaped depression is configured to run circumferentially over a longitudinal expanse of the conveying means. A groove-shaped depression is particularly suitable for being able to center round material at a specific position of the conveying means.

According to a further development, it is possible that the groove-shaped depression has a rounded-off groove bottom, wherein the permanent magnets are disposed centrally below the groove-shaped depression. It is advantageous, in this regard, that the result can be achieved, by means of the rounded-off groove bottom, that even round materials having different diameters always come to lie at the lowest point of the groove bottom, and thereby the height position of the round material is also established. As a result, it can be achieved that the round material is introduced into the cut-to-length apparatus in centered and correctly positioned manner, and thereby the precision of the machining system can once again be increased.

An embodiment according to which it can be provided that the permanent magnets are configured as centering elements is also advantageous, wherein they have a width between 2 mm and 20 mm, particularly between 5 mm and 15 mm, preferably between 7 mm and 13 mm, and are disposed at a predetermined position in the width of the conveying means. By means of this embodiment of the permanent magnets, the permanent magnets can act as a centering element. Thus, not only can it be achieved, by means of the permanent magnets, that the round material is fixed in place on the accommodation surface of the conveying means, but also that the round material is positioned and centered on the accommodation surface, so that it can be introduced well into the cut-to-length apparatus.

Furthermore, it can be provided that the conveying means has recesses that extend over the width of the conveying means and are configured proceeding from the accommodation surface in the direction of an inner surface of the conveying means. It is advantageous, in this regard, that the effective thickness of the conveying means can be reduced by the recesses, and thereby the minimal diameter of a deflection station, in particular a deflection roller, can be reduced. As a result, the effective accommodation region of the conveying means can be displaced closer to the cut-to-length apparatus, thereby making it possible to be able to feed even shorter round materials to the cut-to-length apparatus, or to take them over from the cut-to-length apparatus.

Furthermore, it can be practical that the conveying means is configured as a toothed belt. It is advantageous, in this regard, that the position of the conveying means relative to a drive roller or relative to the drive motor can be established precisely, and thereby the round material can be positioned with great precision.

Furthermore, it can be provided that a photoelectric barrier is disposed in the region of the feeder apparatus. It is advantageous, in this regard, when a new raw material rod is fed in, that the end-side beginning of the raw material can be precisely determined, and that it is not necessary for an initial cut or even a reference cut to be carried out in order to obtain a defined end surface. As a result, the machining time can be reduced, for one thing, since the initial cut can be eliminated. Furthermore, the amount of the waste material that occurs can also be reduced as a result.

Furthermore, it can be provided that the cut-to-length apparatus has a fixed first shear disk having a first passage bore, and a second shear disk that can rotate relative to the first shear disk, having a second passage bore, wherein the passage bores are disposed at a distance from the rotation axis of the shear disks, and the two passage bores can be displaced relative to one another by means of rotation of the second shear disk. It is advantageous, in this regard, that a cut-to-length apparatus configured in this manner is particularly suitable for round materials, wherein it has surprisingly been shown that a particularly precise cut of the round material can be achieved in interaction with the conveying means according to the invention, with the permanent magnets accommodated in it.

According to a special embodiment, it is possible that at least two passage bores having different diameters and lying on a straight line are disposed on the two shear disks, and that the two shear disks can be displaced relative to the feeder apparatus, wherein the displacement direction runs parallel to the straight line. It is advantageous, in this regard, that as a result, different round materials having different diameters can be cut to length by means of the cut-to-length apparatus, wherein the result can be achieved, by means of the passage bores having different diameters, that the precision of the cut to length does not vary with different diameters. Because of the linear arrangement of the passage bores on a straight line, the result can be achieved that a variation can take place between the different diameters, by means of a linear displacement of the two shear disks.

In accordance with an advantageous further development, it can be provided that multiple arrangements of passage bores having different diameters, which arrangements have the same configuration, are disposed distributed over the circumference, wherein the two shear disks are accommodated in the cutting apparatus so as to rotate in pairs, and only one of the arrangements of passage bores is provided for the shearing process at all times. It is advantageous, in this regard, that in the case of wear of one of the shear disks, in particularly in an arrangement of passage bores, the shear disks can be rotated, and thereby a new arrangement of passage bores can be used for the cutting process. As a result, the overall useful lifetime of the shear disks can be increased. Furthermore, the precision of the machining system can be improved as a result.

In particular, it can be advantageous if the second shear disk is coupled with a rotation lever that is coupled with a rod assembly, wherein the rod assembly is eccentrically mounted on a shaft that is coupled with an electric motor, preferably a servomotor. It is advantageous, in this regard, that by means of these measures, the drive for the cut-to-length apparatus has the simplest possible structure, and thereby has little susceptibility to failure. Furthermore, by means of the configuration of the rotation lever, the result can be achieved that a great shear force can be applied by way of the lever effect, using a comparatively low motor force.

Furthermore, it can be provided that a removal apparatus is configured in the form of a belt conveyor, wherein permanent magnets are disposed in the conveying means of the removal apparatus, which are positioned below an accommodation surface for accommodating round material, wherein the round material can be fixed in place on the accommodation surface of the conveyor belt by means of the permanent magnets. It is advantageous, in this regard, that the finished round material rods that have been cut to length can be taken over by the removal apparatus and supplied to their further use.

Furthermore, it can be practical that the feeder apparatus is driven by a servomotor. It is advantageous, in this regard, that the feeder apparatus can be precisely controlled by means of the servomotor, and therefore the machining system can demonstrate great precision.

For a better understanding of the invention, it will be explained in greater detail using the following figures.

The figures show, each in a greatly simplified, schematic representation:

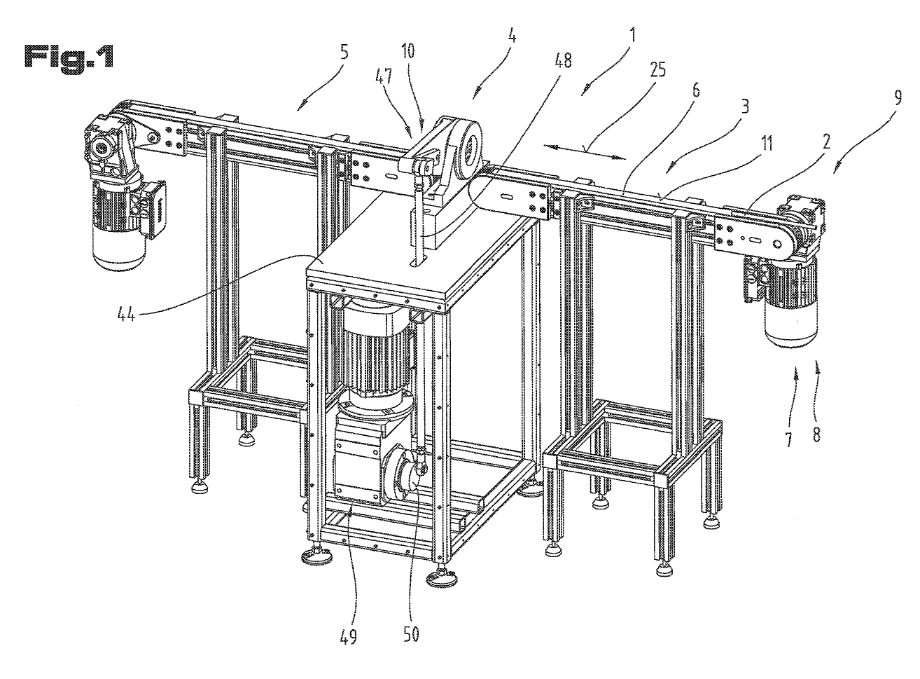

FIG. 1 a perspective view at a slant from above of an exemplary embodiment of a machining system;

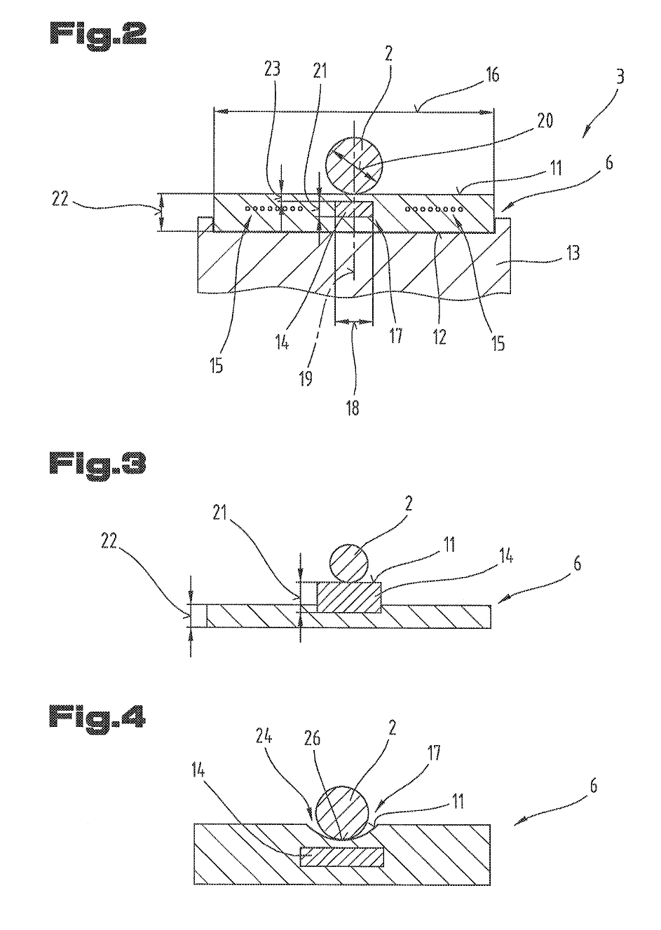

FIG. 2 a cross-sectional representation of a first exemplary embodiment of a conveyor belt;

FIG. 3 a cross-sectional representation of a second exemplary embodiment of the conveyor belt;

FIG. 4 a cross-sectional representation of a third exemplary embodiment of the conveyor belt;

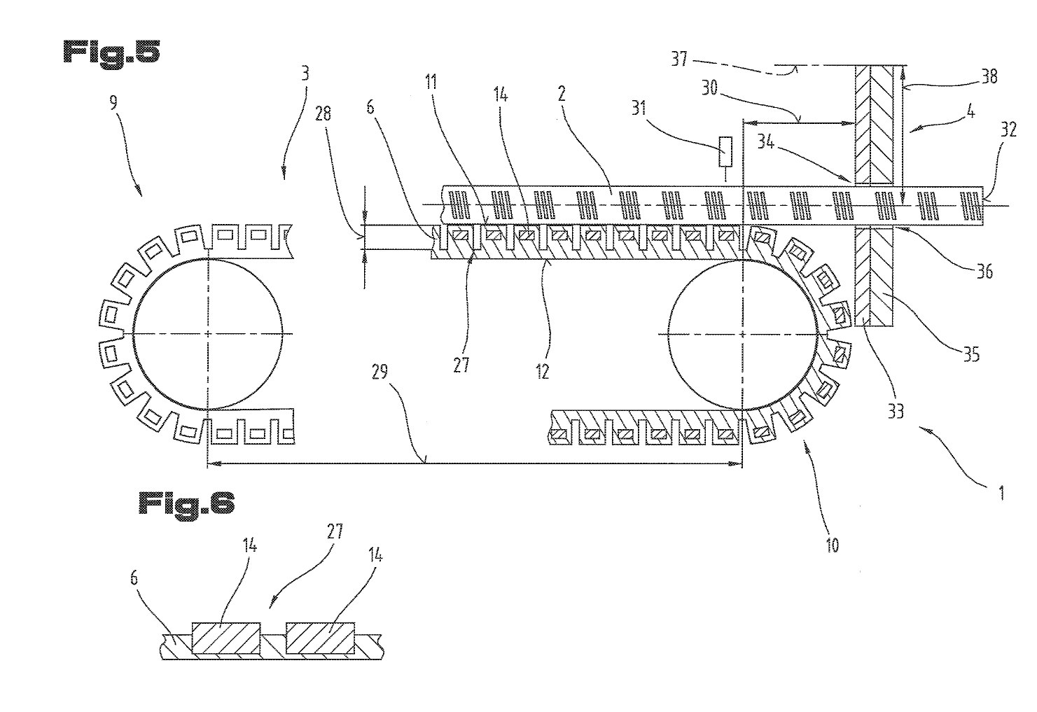

FIG. 5 a longitudinal sectional representation of an exemplary embodiment of the conveyor belt;

FIG. 6 a longitudinal sectional representation of a further exemplary embodiment of a conveyor belt;

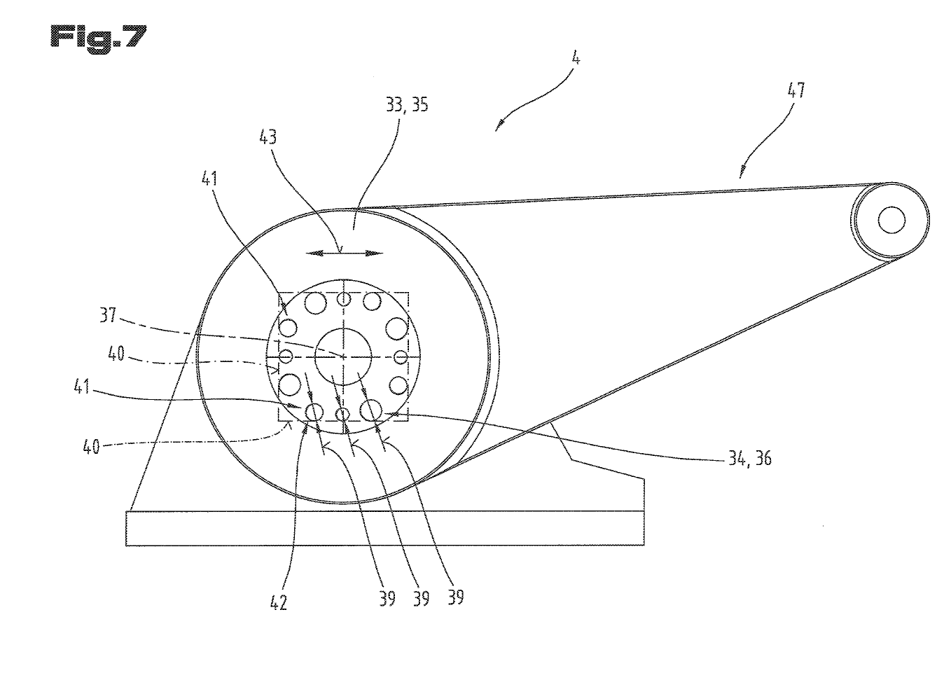

FIG. 7 a side view of an exemplary embodiment of a cut-to-length apparatus;

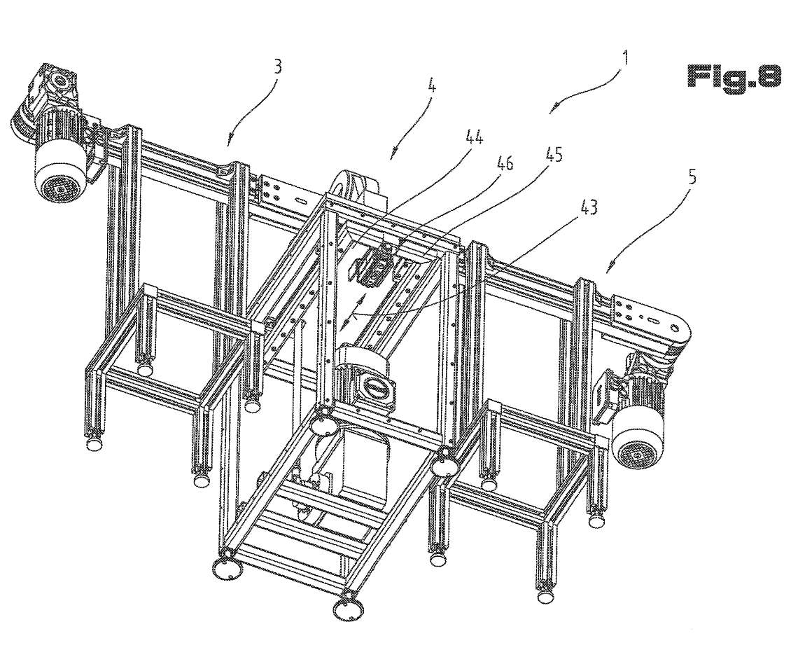

FIG. 8 a perspective view at a slant from below of an exemplary embodiment of a machining system.

As an introduction, it should be stated that in the different embodiments described, the same parts are provided with the same reference symbols or the same component designations, wherein the disclosures contained in the description as a whole can be transferred analogously to the same parts having the same reference symbols or the same component designations. Also, the position information selected in the description, such as top, bottom, at the side, etc., for example, refer to the figure being directly described and shown, and this position information must be applied appropriately to the new position if a change in position occurs.

FIG. 1 shows a perspective view of a machining system 1 for cutting round materials 2 to length. The round material 2 can be configured, in particular, as concrete-reinforcing steel. Such concrete-reinforcing steel has a ribbed surface, whereby making handling more difficult, particularly when cutting the concrete-reinforcing steel to length. The concrete-reinforcing steel can be present either as a rod material or as a wire material wound up onto a reel. If the concrete-reinforcing steel is wound up onto a reel, it is unwound from the reel before being fed to the machining system 1 and straightened, so that it lies straight when it is feed into the machining system 1.

The machining system 1 comprises a feeder apparatus 3, which serves for feeding the round material to a cut-to-length apparatus 4 and positioning it. Furthermore, a removal apparatus 5 can be provided, which takes the finished, cut-to-length round material 2 over from the cut-to-length apparatus 4, and transports it away from the latter.

The feeder apparatus 3 is configured in the form of a belt conveyor, which has a conveying means 6. In a preferred embodiment variant, the conveying means 6 is configured as a conveyor belt, and for this reason, for the sake of simplicity, a conveyor belt 6 will be spoken of in the further description.

However, it is explicitly pointed out that a conveying means 6 configured in a different manner is also understood to be a conveying means 6 in the sense of this document, which means can be passed around deflection rollers as an endless, closed pulling means. This can also be a chain, for example.

The conveyor belt 6 is driven by a drive unit 7, which can be configured, in particular, as a servomotor 8. The servomotor 8 has the advantage that the conveyor belt 6 can be precisely positioned. Alternatively to a servomotor 8, a stepper motor can also be used as a drive unit 7, for example, wherein an additional sensor is required that detects the current position of the conveyor belt 6. Such a sensor can be configured in the form of an angle of rotation sensor, for example, which can be coupled with a drive station 9 or a deflection station 10 of the belt conveyor. The drive station 9 and the deflection station 10 have a drive roller and a deflection roller, respectively, between which the conveyor belt 6 is stretched. Furthermore, the sensor can be configured as an incremental sensor, for example, which reads an incremental strip disposed on the conveyor belt 6.

In an alternative variant, it is also conceivable that an angle of rotation sensor is disposed on a measurement roller, which roller is disposed on the belt conveyor between drive station 9 and deflection station 10.

In order to be able to increase the precision of the positioning of the conveyor belt 6, it can be provided that the conveyor belt 6 is configured in the form of a toothed belt. In this regard, it is practical if at least the drive roller of the drive station 9 has a corresponding gearing for engagement into the toothed belt.

FIG. 2 shows an exemplary embodiment of the conveyor belt 6 with the round material 2 disposed on it, in a cross-sectional representation.

As is evident from FIG. 2, it is provided that the round material 2 lies on an accommodation surface 11 of the conveyor belt 6. The inner surface 12 of the conveyor belt 6 is disposed opposite the accommodation surface 11; it can be guided on a support unit 13 of the belt conveyor.

In a further embodiment variant, it can be provided that no support unit 13 is formed, on which the conveyor belt 6 rests, but rather that the conveyor belt 6 is stretched between drive station 9 and deflection station 10 in self-supporting manner.

As is furthermore evident from FIG. 2, it is provided that multiple permanent magnets 14 are configured in the conveyor belt 6, by means of which magnets the round material 2 can be fixed in place on the accommodation surface 11 of the conveyor belt 6. In particular, the result is achieved, by means of the magnetic force of the permanent magnets 14, that the round material 2 is pressed against the accommodation surface 11 of the conveyor belt 6, and thereby the friction force between round material 2 and conveyor belt 6 is increased. This leads to the result that the round material 2 can be precisely positioned in the cut-to-length apparatus 4 by means of the conveyor belt 6.

In order to further increase the friction force between round material 2 and conveyor belt 6, it can be provided that the accommodation surface 11 has a specific surface roughness. Furthermore, it can be provided that the accommodation surface 11 has a coating, in order to be able to increase the friction coefficient or the wear resistance of the conveyor belt 6. Such a coating can be a special rubber material or some other plastic material, for example. Furthermore, it is conceivable that the conveyor belt 6 has a core material 15 that serves to absorb the tensile forces in the conveyor belt 6. The core material 15 can be formed as a woven textile, by means of plastic fibers, by means of steel fibers, or in some other way, for example.

The conveyor belt 6 can consist, for the most part, of a plastic material, in particular of a rubber-like material.

In order to be able to feed the round material 2 advantageously into the cut-to-length apparatus 4, it is necessary that the round material 2 is centered at a predetermined position with reference to the width 16 of the conveyor belt 6. This can be achieved in that a centering element 17 is configured in the feeder apparatus 3, which element centers the round material 2 in a specific position with reference to the width 16 of the conveyor belt 6.

As is evident from FIG. 2, it can be provided that the permanent magnets 14 themselves are configured as a centering element 17, wherein the width 18 of the permanent magnets 14 amounts to between 2 mm and 20 mm. By means of this limited width of the permanent magnets 14, the round material 2 is pulled to that position at which an active center 19 of the permanent magnet 14 is situated. In particular, it is conceivable that the width 18 is adapted to the planned diameter 20 of the round material 2. The machining system 1 is preferably designed for round material 2 having a diameter 20 of 4 mm to 16 mm. The diameter 20 of the round material 2 can amount to 4 mm, 6 mm, 8 mm, 10 mm, 12 mm, 14 mm or 16 mm, for example.

As is evident from FIG. 2, it can be provided that a thickness 21 of the permanent magnet 14 is selected to be less than the thickness 22 of the conveyor belt 6. As a result, it can be achieved that the permanent magnet 14 is accommodated in the conveyor belt 6 with a covering 23. In particular, in this way the result can be achieved that the permanent magnet 14 cannot fall out of the conveyor belt 6.

In FIG. 3, a further embodiment of the conveyor belt 6, which can be independent, is shown, wherein once again, the same reference symbols and component designations as in the preceding FIG. 2 are used for the same parts. In order to avoid unnecessary repetition, reference is made to the detailed description in the preceding FIG. 2, i.e. this is pointed out.

As is evident from FIG. 3, it can be provided that the permanent magnet 14 projects out of the conveyor belt 6 and thereby the accommodation surface 11 on which the round material 2 lies is configured directly on the permanent magnet 14. In the case of such an embodiment variant, the thickness 22 of the conveyor belt 6 can be kept low in comparison with the thickness 21 of the permanent magnet 14, and thereby the result can be achieved that the deflection roller and the drive roller can have the smallest possible diameter, since the flexibility of the conveyor belt 6 can be increased.

In FIG. 4, a further embodiment of the conveyor belt 6, which can be independent, is shown, wherein once again, the same reference symbols and component designations as in the preceding FIGS. 2 and 3 are used for the same parts. In order to avoid unnecessary repetition, reference is made to the detailed description in the preceding FIGS. 2 and 3, i.e. this is pointed out.

As is evident from FIG. 4, it can be provided that the centering element 17 is configured in the form of a groove-shaped depression 24, which is disposed on the accommodation surface 11 of the conveyor belt 6. The groove-shaped depression 24 extends over a longitudinal expanse 25 of the conveyor belt 6. Stated in other words, the groove-shaped depression 24 is disposed circumferentially on the conveyor belt 6.

As is evident from FIG. 4, it is preferably provided that a groove bottom 26 of the groove-shaped depression 24 has a rounding, so that the round material 2 always lies at the deepest point of the groove bottom 26. As a result, it can be achieved that the contact point between round material 2 and accommodation surface 11 always lies at the same height even in the case of different round materials 2 having different diameters 20.

In an alternative embodiment variant, it can also be provided that the groove-shaped depression 24 is configured in the form of a V-shaped groove.

The removal apparatus 5 can have all of the characteristics of the feeder apparatus 3. In particular, it can be provided that the removal apparatus 5 and the feeder apparatus 3 are configured to be identical to one another.

In FIG. 5, a schematic longitudinal section of a further embodiment of the conveyor belt 6, which can also be independent, is shown, wherein once again, the same reference symbols and component designations as in the preceding FIGS. 1 to 4 are used for the same parts. In order to avoid unnecessary repetition, reference is made to the detailed description in the preceding FIGS. 1 to 4, i.e. this is pointed out.

As is evident from FIG. 5, it can be provided that the conveyor belt 6 has recesses 27, which extend in the direction of the inner surface 12, proceeding from the accommodation surface 11. The recesses 27 have a recess depth 28 that is less than the thickness 22 of the conveyor belt 6. By means of the recesses 27, the result can be achieved that the conveyor belt can be deflected about a deflection roller having only a slight diameter. As a result, an effective accommodation region 29 of the feeder apparatus 3 can be increased, and, accompanying this, a contact distance 30 between the cut-to-length apparatus 4 and the effective accommodation region 29 can be reduced. The shorter the contact distance 30, the shorter the residual length of the cut rod material can be, and the waste is less.

Furthermore, a photoelectric barrier 31 can be provided in the region of the feeder apparatus 3, by means of which the end surface 32 of the round material 2 can be detected when a new rod material is fed in.

The individual permanent magnets 14 can be accommodated between the recesses 27 in the conveyor belt 6.

As is evident from FIG. 5, it can be provided that the cut-to-length apparatus 4 comprises a first, fixed shear disk 33 having a first passage bore 34, and a second shear disk 35 having a second passage bore 36. The passage bores 34, 36 overlap one another in the state of rest. As a result, the round material 2 can be guided through both passage bores 34, 36. To cut or shear the round material 2 off, the second shear disk 35 is rotated with reference to a rotation axis 37, and thereby the second passage bore 36, which is disposed at a distance 38 relative to the rotation axis 37, is displaced relative to the first passage bore 34. As a result, the round material 2 guided through the passage bores 34, 36 is sheared off.

In FIG. 6, a schematic longitudinal section of a further embodiment of the conveyor belt 6, which can be independent, is shown, wherein once again, the same reference symbols and component designations as in the preceding FIGS. 1 to 5 are used for the same parts. In order to avoid unnecessary repetition, reference is made to the detailed description in the preceding FIGS. 1 to 5, i.e. this is pointed out.

As is evident from FIG. 6, it can be provided that the recesses 27 are configured directly between the individual permanent magnets 14.

In FIG. 7, a side view of a further embodiment of the cut-to-length apparatus 4, which can be independent, is shown, wherein once again, the same reference symbols and component designations as in the preceding FIGS. 1 to 6 are used for the same parts. In order to avoid unnecessary repetition, reference is made to the detailed description in the preceding FIGS. 1 to 6, i.e. this is pointed out.

In FIG. 8, a perspective view at a slant from below of a further embodiment of the machining system 1, which can be independent, is shown, wherein once again, the same reference symbols and component designations as in the preceding FIGS. 1 to 7 are used for the same parts. In order to avoid unnecessary repetition, reference is made to the detailed description in the preceding FIGS. 1 to 7, i.e. this is pointed out.

The precise function of the machining system 1 and its structure will be explained while looking at FIGS. 1, 5, 7, and 8 together.

As is evident from FIG. 7, it can be provided that multiples of the passage bores 34, 36 are disposed on the shear disks 33, 35, in order to be able to shear off round materials 2 having different diameters. In this regard, it can be provided that the individual passage bores 34, 36 have different diameters 39. As can be seen particularly well in FIG. 7, it can be provided that multiples of the passage bores 34, 36 are disposed to lie on a straight line 40. Thereby the passage bores 34, 36 form an arrangement 41, in each instance. In particular, it can be provided that the passage bores 34, 36 are oriented relative to one another in such a manner that the straight line 40 lies tangentially against and relative to the mantle surfaces of the passage bores 34, 36 that are disposed in the arrangement 41.

As a result, it can be achieved that a lower edge 42 of all the passage bores 34, 36 of an arrangement 41 corresponds with the accommodation surface 11 of the feeder apparatus 3.

In order to be able to use the different passage bores 34, 36 having different diameters 39, it can be provided that the complete cut-to-length apparatus 4 can be displaced in a horizontal displacement direction 43 relative to the feeder apparatus 3. The individual passage bores 34, 36 can thereby be configured for a specific diameter of the round material 2, wherein the diameter 39 of the passage bores 34, 36 is selected to be slightly greater than the diameter of the round material 2 to be machined.

As can be seen particularly well in FIG. 8, it can be provided that for displacement of the cut-to-length apparatus 4 in the displacement direction 43, all the components of the cut-to-length apparatus 4 are disposed on a displacement plate 44. The displacement plate 44 is disposed on a basic frame 45 by means of a linear guide. An actuator 46 can be configured to displace the displacement plate 44. The actuator 46 can be configured in the form of a pneumatic cylinder, for example. Furthermore, it can be provided that the actuator 46 is configured as a three-position cylinder. Such a three-position cylinder has two piston rods, and thereby the displacement plate 44 can be positioned in three different positions with reference to the displacement direction 43.

In order to increase the overall useful lifetime of the shear disks 33, 35, it can be provided that multiple arrangements 41 of passage bores 34, 36 are configured distributed over the circumference of the shear disks 33, 35. If the shear disks 33, 35 are built into the cut-to-length apparatus 4 rotated by 90°, for example, then a new, as yet unused arrangement 41 of passage bores 34, 36 can be used.

Furthermore, it can be provided that the second shear disk 35 is coupled with a rotation lever 47, by means of which the shear disk 35 can be rotated with reference to the rotation axis 37. The rotation lever 47 can be coupled with a drive unit, in particular an electric motor 49, by means of a rod assembly 48. In this regard, it can be provided that the rod assembly 48 is mounted eccentrically on a shaft 50, which is coupled with the electric motor 49. Thereby the rotation lever 47 can be moved by a rotation of the shaft 50 by means of the rod assembly 48, and thereby the second passage bore 36 can be displaced relative to the first passage bore 34.

Preferably, it can be provided that the electric motor 49 is configured as a servomotor, and thereby the angle of rotation position of the shaft 50 can be precisely controlled. Furthermore, it can be provided that the electric motor 49 has a reduction gear or is coupled with a reduction gear.

The exemplary embodiments show possible embodiment variants, wherein it is noted at this point that the invention is not restricted to the specifically shown embodiments variants of the same, but rather also various combinations of the individual embodiment variants with one another are possible, and this variation possibility lies within the ability of a person skilled in the art of this technical field, on the basis of the teaching for technical action provided by the present invention.

The scope of protection is determined by the claims. However, the description and the drawings should be referred to for an interpretation of the claims. Individual characteristics or combinations of characteristics from the different exemplary embodiments that are shown and described can represent independent inventive solutions in and of themselves. The task underling the independent inventive solutions can be derived from the description.

All information regarding value ranges in the present description should be understood to mean that these include any and all partial ranges of them; for example, the information 1 to 10 should be understood to mean that all partial ranges, proceeding from the lower limit 1 and the upper limit 10, i.e. all partial ranges, beginning with a lower limit of 1 or more and ending with an upper limit of 10 or less, for example 1 to 1.7, or 3.2 to 8.1, or 5.5 to 10, are included.

For the sake of good order, it should be pointed out, in conclusion, that for a better understanding of the structure, elements were shown not to scale and/or enlarged and/or reduced in size, in part, wherein the position of the elements relative to one another and also the size ratios of the elements are supposed to impart a recognizable and implementable teaching for technical action to a person skilled in the relevant art, and do not arise from the artistic freedom of the illustrator.

### REFERENCE SYMBOL LISTING

1 machining system

2 round material

3 feeder apparatus

4 cut-to-length apparatus

5 removal apparatus

6 conveying means

7 drive unit

8 servomotor

9 drive station

10 deflection station

11 accommodation surface

12 inner surface

13 support unit

14 permanent magnet

15 core material

16 wide conveying means

17 centering element

18 wide permanent magnet

19 active center of permanent magnet

20 diameter of round material

21 thick permanent magnet

22 thick conveying means

23 covering of permanent magnet

24 groove-shaped depression

25 longitudinal expanse

26 groove bottom

27 recess

28 recess depth

29 effective accommodation region

30 contact distance

31 photoelectric barrier

32 end surface

33 first shear disk

34 first passage bore

35 second shear disk

36 second passage bore

37 rotation axis

38 distance

39 diameter

40 straight line

41 arrangement of passage bores

42 lower edge

43 displacement direction

44 displacement plate

45 basic framework

46 actuator

47 rotation lever

48 rod assembly

49 electric motor

50 shaft

1. A machining system (1) for machining round material (2), in particular concrete-reinforcing steel, the machining system (1) comprising a feeder apparatus (3) for feeding and positioning the round material (2), and a machining apparatus, in particular a cut-to-length apparatus (4) for cutting the round material (2) to length, wherein the feeder apparatus (3) is configured as a belt conveyor, wherein permanent magnets (14) are disposed on a conveying means (6), such as a conveyor belt, for example, which magnets are positioned below an accommodation surface (11) for accommodating round material (2), wherein the round material (2) can be fixed in place on the accommodation surface (11) of the conveying means (6) by means of the permanent magnets (14).

2. The machining system according to claim 1, wherein the conveying means (6) is configured in such a manner that the round material (2) can be centered on the conveying means (6) at a predetermined position, with reference to the width (16) of the conveying means (6), by means of a centering element (17).

3. The machining system according to claim 2, wherein the centering element (17) is configured in the form of a groove-shaped depression (24), which is disposed on the accommodation surface (11) of the conveying means (6), wherein the groove-shaped depression (24) is configured to run circumferentially over a longitudinal expanse (25) of the conveying means (6).

4. The machining system according to claim 3, wherein the groove-shaped depression (24) has a rounded-off groove bottom (26), wherein the permanent magnets (14) are disposed centrally below the groove-shaped depression (24).

5. The machining system according to claim 2, wherein the permanent magnets (14) are configured as centering elements (17), wherein they have a width (18) between 2 mm and 20 mm, particularly between 5 mm and 15 mm, preferably between 7 mm and 13 mm, and are disposed at a predetermined position in the width (16) of the conveying means (6).

6. The machining system according to claim 1, wherein the conveying means (6) has recesses (27) that extend over the width (16) of the conveying means (6) and are configured proceeding from the accommodation surface (11) in the direction of an inner surface (12) of the conveying means (6).

7. The machining system according to claim 1, wherein the conveying means (6) is configured as a toothed belt.

8. The machining system according to claim 1, wherein an optical detection means, in particular a photoelectric barrier (31), is disposed in the region of the feeder apparatus (3).

9. The machining system according to claim 1, wherein the cut-to-length apparatus (4) has a fixed first shear disk (33) having a first passage bore (34), and a second shear disk (35) that can rotate relative to the first shear disk (33), having a second passage bore (36), wherein the passage bores (34, 36) are disposed at a distance (38) from the rotation axis (37) of the shear disks (33, 35), and the two passage bores (34, 36) can be displaced relative to one another by means of rotation of the second shear disk (35).

10. The machining system according to claim 9, wherein at least two passage bores (34, 36) having different diameters (39) and lying on a straight line (40) are disposed on the two shear disks (33, 35), and that the two shear disks (33) can be displaced relative to the feeder apparatus (3), wherein the displacement direction (43) runs parallel to the straight line (40).

11. The machining system according to claim 10, wherein multiple arrangements (41) of passage bores (34, 36) having different diameters (39), which arrangements have the same configuration, are disposed distributed over the circumference, wherein the two shear disks (33, 35) are accommodated in the cutting apparatus so as to rotate in pairs, and only one of the arrangements (41) of passage bores (34, 36) is provided for the shearing process at all times.

12. The machining system according to claim 9, wherein the second shear disk (35) is coupled with a rotation lever (47) that is coupled with a rod assembly (48), wherein the rod assembly (48) is eccentrically mounted on a shaft (50) that is coupled with an electric motor (49), preferably a servomotor.

13. The machining system according to claim 1, wherein a removal apparatus (5) is configured in the form of a belt conveyor, wherein permanent magnets (14) are disposed in the conveying means (6) of the removal apparatus (5), which are positioned below an accommodation surface (11) for accommodating round material (2), wherein the round material (2) can be fixed in place on the accommodation surface (11) of the conveying means (6) by means of the permanent magnets (14).

14. The machining system according to claim 1, wherein the feeder apparatus (3) is driven by a servomotor (8).
